(19) United States
(12) Patent Application Publication
(10) Pub. No.: US 2011/0103760 A1
(43) Pub. Date: May 5, 2011

(54) Mounting Clips for Mounting Fiber Optic Equipment and Apparatuses and Related Methods

(76) Inventors: Monique L. Côté, Fort Worth, TX (US); Brent M. Frazier, Haslet, TX (US); Raymond G. Jay, Mansfield, TX (US); Michael H. Rasmussen, Keller, TX (US)

(21) Appl. No.: 12/609,089

(22) Filed: Oct. 30, 2009

(51) Int. Cl. G02B 6/00

(52) U.S. Cl. 385/135

(57) ABSTRACT

Mounting clips and fiber optic equipment and apparatuses that include one or more mounting clips for mounting fiber optic equipment and related methods are disclosed. The mounting clips allow fiber optic equipment to be easily installed or mounted for storage, such as in, for example, fiber optic equipment racks or cabinets. In one embodiment, a fiber optic apparatus is provided comprising a housing and at least one optical component supported in the housing. At least one mounting clip is attached to at least one side of the housing of the fiber optic equipment. The mounting clip is configured to receive at least one mounting bracket configured to be installed on a fiber optic equipment rack. In this manner, when the mounting clip is received or attached to the mounting bracket, the housing of the fiber optic equipment is secured to the fiber optic equipment rack.

### BACKGROUND

1. Field of the Disclosure

The technology of the disclosure relates to mounting of fiber optic equipment and apparatuses in an equipment frame, rack, or cabinet.

2. Technical Background

Benefits of optical fiber include extremely wide bandwidth and low noise operation. Because of these advantages, optical fiber is increasingly being used for a variety of applications, including but not limited to broadband voice, video, and data transmission. Fiber optic networks employing optical fiber are being developed and used to deliver voice, video, and data transmissions to subscribers over both private and public networks. These fiber optic networks often include separated connection points linking optical fibers to provide “live fiber” from one connection point to another connection point. In this regard, fiber optic equipment is located in data distribution centers or central offices to support optical fiber interconnections.

The fiber optic equipment is customized based on the application need. Examples of fiber optic equipment include fiber optic modules and patch panels. The fiber optic equipment is typically included in a chassis or housing that is mounted inside an equipment rack or cabinet to optimize use of space. The equipment racks typically include frame rails that extend vertically from a floor, wherein the fiber optic equipment is placed inside between the frame rails. The fiber optic equipment contains mounting brackets on left and right sides of the housing. The mounting brackets contain flanges bent at right angles relative to the sides of the housing or chassis through which screws can be placed to install and secure the fiber optic equipment in an equipment rack. In this regard, a typical installation involves a technician holding the fiber optic equipment to be mounted in the equipment rack, while at the same time, aligning holes in both the left-side and right-side mounting brackets to holes in the frame rails of the equipment rack. When properly aligned, the technician then places screws through the holes in the mounting brackets and the holes in the frame rails to hold the fiber optic equipment in place. Holding the fiber optic equipment such that the holes in the mounting brackets are aligned with the holes in the frame rail while also placing and tightening screws through both holes can be difficult for one technician to perform. Thus, it is common for two technicians to install fiber optic equipment. One technician holds the fiber optic equipment in alignment, and another technician inserts and tightens the screws in the mounting bracket holes when aligned with the frame rail holes. Having two technicians to install fiber optic equipment increases installation labor and thus installation costs. It would be desirable to allow a single technician to easily install fiber optic equipment in an equipment rack or housing.

### SUMMARY OF THE DETAILED DESCRIPTION

Embodiments disclosed in the detailed description include mounting clips and fiber optic equipment and apparatuses that include one or more mounting clips for mounting fiber optic equipment and related methods. The mounting clips allow fiber optic equipment to be easily installed or mounted for storage, such as in, for example, fiber optic equipment racks or cabinets. In one embodiment, a fiber optic apparatus is provided comprising a housing and at least one optical component supported in the housing. At least one mounting clip is attached to at least one side of the housing of the fiber optic equipment. The mounting clip can be attached to the housing prior to installation of the fiber optic equipment. The mounting clip is configured to receive at least one mounting bracket configured to be installed on a fiber optic equipment rack. In this manner, when the mounting clip is received or attached to the mounting bracket, the housing of the fiber optic equipment is secured to the fiber optic equipment rack. In one embodiment, the mounting clips are configured to be received by the mounting bracket without the use of fasteners. Further, because the mounting clips can be fastened to the fiber optic equipment prior to installation, the fiber optic equipment can be installed without having to hold the fiber optic equipment in place while, at the same time, fastening the housing of the fiber optic equipment to a fiber optic equipment rack or cabinet.

In another embodiment, a method of installing a fiber optic apparatus in a fiber optic equipment rack is provided. The method comprises attaching at least one mounting bracket to a fiber optic equipment rack or cabinet. At least one mounting clip attached to at least one side of a housing of fiber optic equipment supporting at least one optical component is aligned with at least one mounting bracket attached to the fiber optic equipment rack or cabinet. The mounting bracket(s) is received by the mounting clip(s). The mounting clip(s) is then translated along the mounting bracket(s) to install the fiber optic equipment in the fiber optic equipment rack or cabinet.

Additional features and advantages will be set forth in the detailed description which follows, and in part will be readily apparent to those skilled in the art from that description or recognized by practicing the invention as described herein, including the detailed description that follows, the claims, as well as the appended drawings.

It is to be understood that both the foregoing general description and the following detailed description present embodiments, and are intended to provide an overview or framework for understanding the nature and character of the disclosure. The accompanying drawings are included to provide a further understanding, and are incorporated into and constitute a part of this specification. The drawings illustrate various embodiments, and together with the description serve to explain the principles and operation of the concepts disclosed.

### BRIEF DESCRIPTION OF THE FIGURES

FIG. 1 is a perspective view of exemplary fiber optic equipment having exemplary mounting clips mounted to a housing wherein the mounting clips receive exemplary mounting brackets installed in an exemplary fiber optic equipment rack to install the fiber optic equipment in the fiber optic equipment rack;

FIG. 2 is a perspective view of the fiber optic equipment of FIG. 1 prior to being installed in a fiber optic equipment rack;

FIG. 3 is a perspective view of the rear mounting clip attached to the right side of the fiber optic equipment of FIG. 1 and receiving the mounting bracket in FIG. 1;

FIG. 4 is a perspective view of the rear and front mounting clips attached the right side of the fiber optic apparatus of FIG. 1 and receiving the right-side mounting bracket in FIG. 1;

FIGS. 5A and 5B are perspective views of the front and back sides of a front mounting clip, respectively;

FIG. 5C is a front view of the front mounting clip of FIGS. 5A and 5B;

FIG. 6 is a top view of the mounting clip;

FIGS. 7A and 7B are perspective views of the front and back sides of a rear mounting clip, respectively;

FIG. 7C is a front view of the rear mounting clip of FIGS. 7A and 7B;

FIG. 8 is a perspective view of the right-side mounting bracket configured to receive the front and rear mounting clips of FIGS. 5A-5C and FIGS. 7A-7C, respectively;

FIG. 9 is a perspective view of the right-side mounting bracket receiving both the front and rear mounting clips of FIGS. 5A-5C and FIGS. 7A-7C, respectively;

FIG. 10 is a perspective view of the right-side mounting bracket initially receiving the rear mounting clip of FIGS. 5A-5C before receiving the front mounting clip of FIGS. 7A-7C;

FIG. 11 is a perspective view of the left-side mounting bracket configured to also receive the front and rear mounting clips of FIGS. 5A-5C and FIGS. 7A-7C, respectively;

FIGS. 12A and 12B are right side and left side views, respectively, of the fiber optic equipment of FIG. 4 with an alternate rear mounting clip attached to the housing of the fiber optic equipment;

FIG. 13 is a perspective view of the fiber optic equipment of FIG. 1 with alternate, angled mounting clips attached to the housing of the fiber optic equipment; and

FIGS. 14 and 15 are close-up perspective views of the front and rear angled-mounting clips, respectively, which are attached to the housing of the fiber optic equipment in FIG. 13.

### DETAILED DESCRIPTION

Reference will now be made in detail to the preferred embodiments of the present invention, examples of which are illustrated in the accompanying drawings, in which some, but not all embodiments are shown. Indeed, the concepts may be embodied in many different forms and should not be construed as limited to the embodiments set forth herein; rather, these embodiments are provided so that this disclosure will satisfy applicable legal requirements. Whenever possible, like reference numbers will be used to refer to like components or parts.

Embodiments disclosed in the detailed description include mounting clips and fiber optic equipment and apparatuses that include one or more mounting clips for mounting fiber optic equipment and related methods. The mounting clips allow fiber optic equipment to be easily installed or mounted for storage, such as in, for example, fiber optic equipment racks or cabinets. In one embodiment, a fiber optic apparatus is provided comprising a housing and at least one optical component supported in the housing. At least one mounting clip is attached to at least one side of the housing of the fiber optic equipment. The mounting clip can be attached to the housing prior to installation of the fiber optic equipment. The mounting clip is configured to receive at least one mounting bracket configured to be installed on a fiber optic equipment rack. In this manner, when the mounting clip is received or attached to the mounting bracket, the housing of the fiber optic equipment is secured to the fiber optic equipment rack. In one embodiment, the mounting clips are configured to be received by the mounting bracket without the use of fasteners. Further, because the mounting clips can be fastened to the fiber optic equipment prior to installation, the fiber optic equipment can be installed without having to hold the fiber optic equipment in place while, at the same time, fastening the housing of the fiber optic equipment to a fiber optic equipment rack or cabinet.

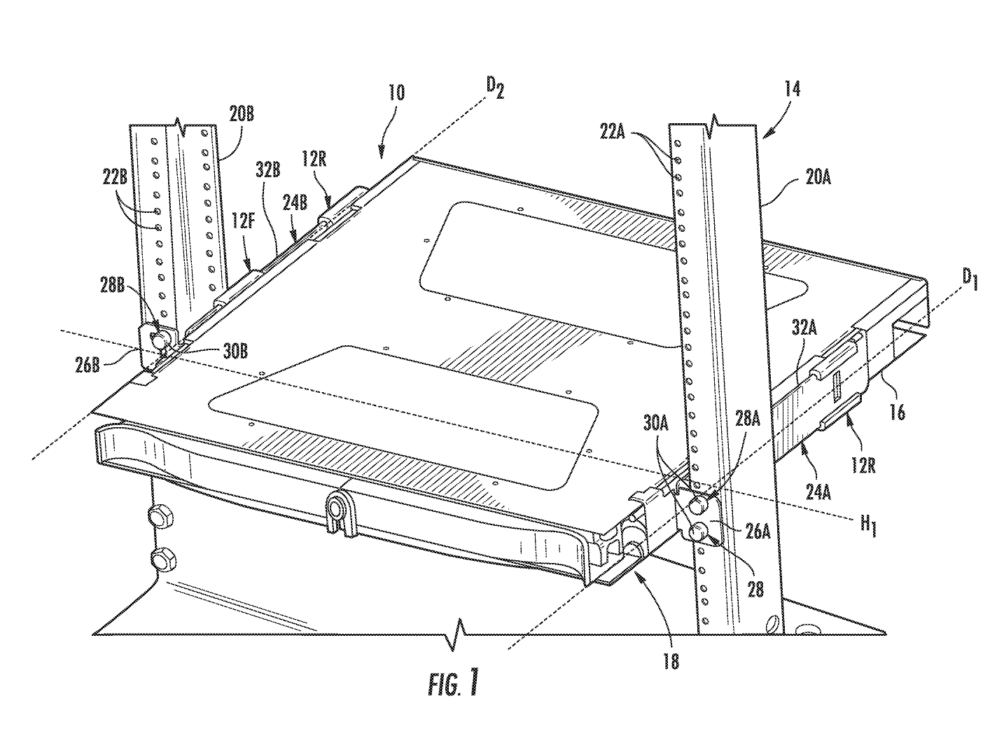

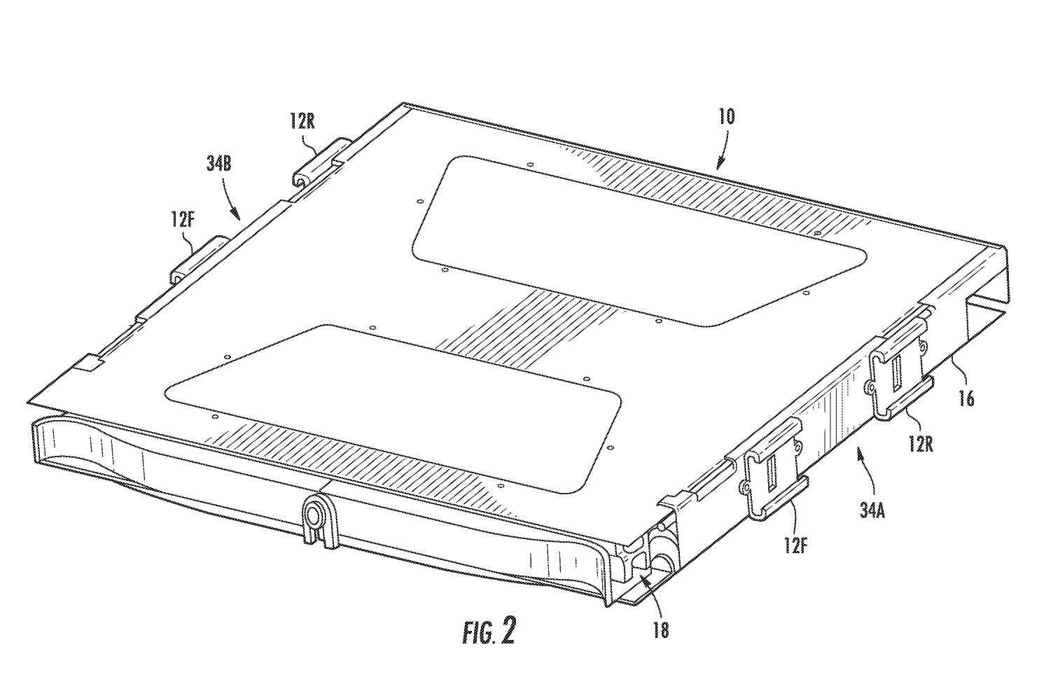

In this regard, FIGS. 1-2 illustrate an exemplary fiber optic equipment or apparatus 10 (hereinafter “fiber optic apparatus 10”) that includes exemplary mounting clips (referred to generally as “mounting clips 12”) for mounting the fiber optic apparatus 10 to an equipment rack 14. FIG. 1 illustrates the fiber optic apparatus 10 with the mounting clips 12 facilitating installation of the fiber optic apparatus 10 in the equipment rack 14. FIG. 2 illustrates the fiber optic apparatus 10 not installed in an equipment rack 14. The equipment rack 14 may be a fiber optic equipment rack designed or used to support fiber optic equipment or apparatuses. The equipment rack 14 may support 1U-sized shelves, with “U” equal a standard 1.75 inches in height, as an example.

As illustrated in FIGS. 1 and 2, and described in greater detail below, the mounting clips 12 allow the fiber optic apparatus 10 to be easily installed or mounted for storage in the equipment rack 14. For example, the fiber optic apparatus 10 may be provided at a data distribution center or central office to support cable-to-cable fiber optic connections and to manage a plurality of fiber optic cable connections. As illustrated in FIGS. 1 and 2, the fiber optic apparatus 10 includes a fiber optic equipment chassis or housing 16 (referred to herein as “housing 16”) that is configured to support one or more optical components 18 supported therein to support fiber optic connections. For example, the fiber optic apparatus 10 can support one or more fiber optic modules (not shown). The fiber optic modules could be fiber optic adapter modules or any other type of fiber optic modules or fiber optic apparatuses, including those that support fiber optic connections. The fiber optic apparatus 10 could include a tilting drawer that includes the optical components as described, for example, in U.S. patent application Ser. No. 12/576,769, entitled “FIBER OPTIC EQUIPMENT SUPPORTING MOVEABLE FIBER OPTIC EQUIPMENT TRAY(S) AND MODULE(S), AND RELATED EQUIPMENT AND METHODS,” incorporated herein by reference in its entirety. Further, the fiber optic apparatus 10 could include one or more fiber optic equipment trays (not shown) that each support one or more fiber optic modules and are independently translatable about the equipment rack 14 for installation, access, and/or removal as described, for example, in U.S. patent application Ser. No. 12/323,423, entitled “REAR-INSTALLABLE FIBER OPTIC MODULES AND EQUIPMENT,” incorporated herein by reference in its entirety.

With reference to FIG. 1, the housing 16 of the fiber optic apparatus 10 is shown as being installed in the equipment rack 14. The equipment rack 14 in this embodiment contains two vertical rails 20A, 20B that extend vertically and include a series of apertures 22A, 22B for facilitating attachment of the fiber optic apparatus 10 inside the equipment rack 14. In this embodiment, two mounting brackets 24A, 24B, a right-side mounting bracket 24A and a left-side mounting bracket 24B, are attached to the vertical rails 20A, 20B. The right-side and left-side mounting brackets 24A, 24B (also referred to herein as “mounting bracket 24A” or “mounting bracket 24B”) each contains flanges 26A, 26B that each contain apertures 28A, 28B configured to align with the apertures 22A, 22B in the vertical rails 20A, 20B. A fastener 30A, 30B or other attachment means, such as a screw for example, is employed to fasten the flanges 26A, 26B to the vertical rails 20A, 20B to secure the mounting brackets 24A, 24B to the vertical rails 20A, 20B. In this manner, the mounting brackets 24A, 24B are secured to the equipment rack 14. Typically, the flanges 26A, 26B of the mounting brackets 24A, 24B are installed in the vertical rails 20A, 20B such that they are aligned in the same horizontal axis H₁. Elongated sections 32A, 32B of the mounting brackets 24A, 24B attached orthogonally or substantially orthogonally to the flanges 26A, 26B extend in the depth axis D₁, D₂, respectively, of the equipment rack 14, as illustrated in FIG. 1, to receive the mounting clips 12 attached to the fiber optic apparatus 10, as described in more detail below.

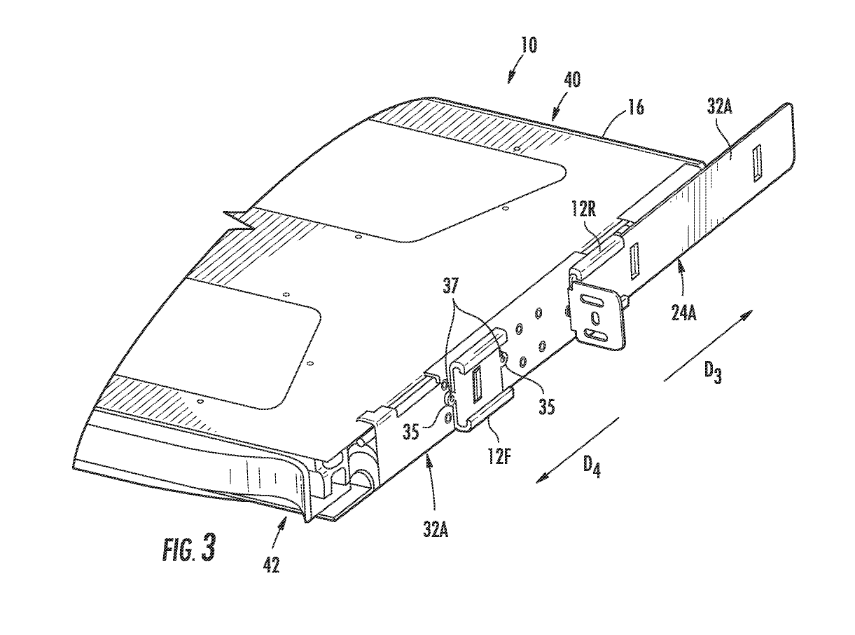

To install the fiber optic apparatus 10 to the equipment rack 14, the mounting clips 12 attached to the fiber optic apparatus 10 are received by the elongated sections 32A, 32B of the mounting brackets 24A, 24B, as illustrated in FIG. 1. In this embodiment, as illustrated in FIG. 2, the mounting clips 12 are attached on the right side 34A and left side 34B of the housing 16 so that the mounting clips 12 can be aligned with the elongated sections 32A, 32B of the mounting brackets 24A, 24B, as illustrated in FIG. 1. The mounting clips designated 12F in FIGS. 1-3 are front mounting clips (“front mounting clips 12F”) in this embodiment. The mounting clips designated 12R in FIGS. 1-3 are rear mounting clips (“rear mounting clips 12R”) in this embodiment. The front and rear mounting clips 12F, 12R are attached to the housing 16 in this embodiment via fasteners 35 which are disposed in apertures 37 disposed in the front and rear mounting clips 12F, 12R, as illustrated in FIG. 3.

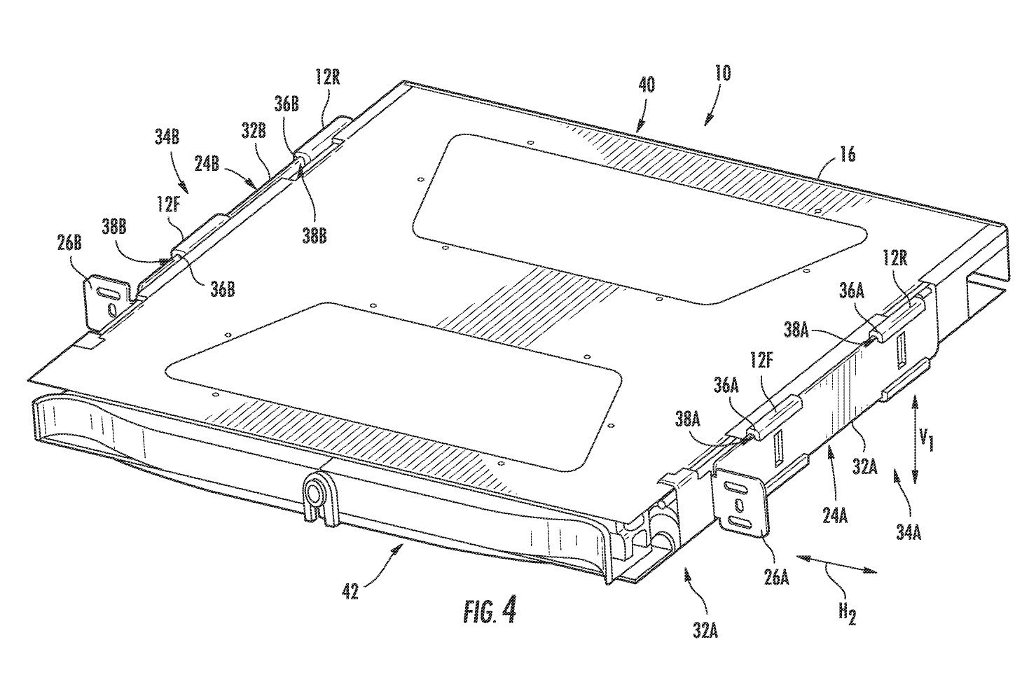

During installation of the fiber optic apparatus 12 to the equipment rack 14, either the front mounting clip 12F or the rear mounting clip 12R is first received by the elongated sections 32A of the mounting bracket 24A. In this embodiment, the rear mounting clip 12R attached to the housing 16 is first received by the elongated section 32A of the mounting bracket 24A, as illustrated in FIG. 3. The fiber optic apparatus 10 is moved or pushed back in the depth direction (indicated as direction D₃ in FIG. 3) after the rear mounting clip 12R receives the elongated section 32A until the elongated section 32A also receives the front mounting clip 12F attached to the housing 16, as illustrated in FIG. 4. Because the left-side mounting bracket 24B is also installed on the vertical rail 20B and aligned in the horizontal axis H with right-side mounting bracket 24A in this embodiment as illustrated in FIG. 1, the front and rear mounting clips 12F, 12R attached to the left side 34B (FIG. 2) of the housing 16 are likewise received by the elongated section 32B of the left-side mounting bracket 24B. This is illustrated in FIG. 4. In this manner, both the right and left sides 34A, 34B of the housing 16 of the fiber optic apparatus 10 is installed in the equipment rack 14. Note that there is no requirement to include both a front and rear mounting clip 12F, 12R on right and/or left sides 34A, 34B of the housing 16 of the fiber optic apparatus 10. Alternatively, one or more than two mounting clips 12 may be attached to one side 34 or both the right and left sides 34A, 34B of the housing 16. Providing more than one mounting clip 12 on a side 34 of the housing 16 lessens the force applied by the housing 16 on each mounting clip 12 and may reduce torsional forces applied to the mounting clips 12 as the housing 16 translates about the mounting brackets 24A, 24B.

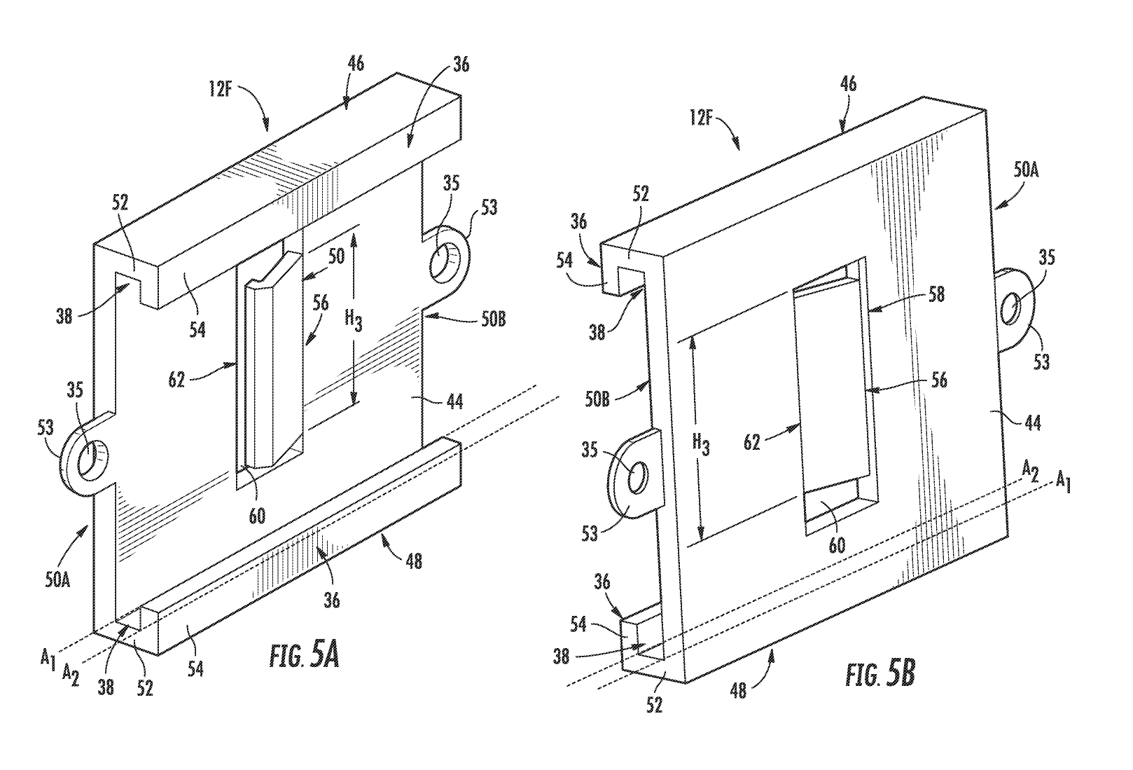

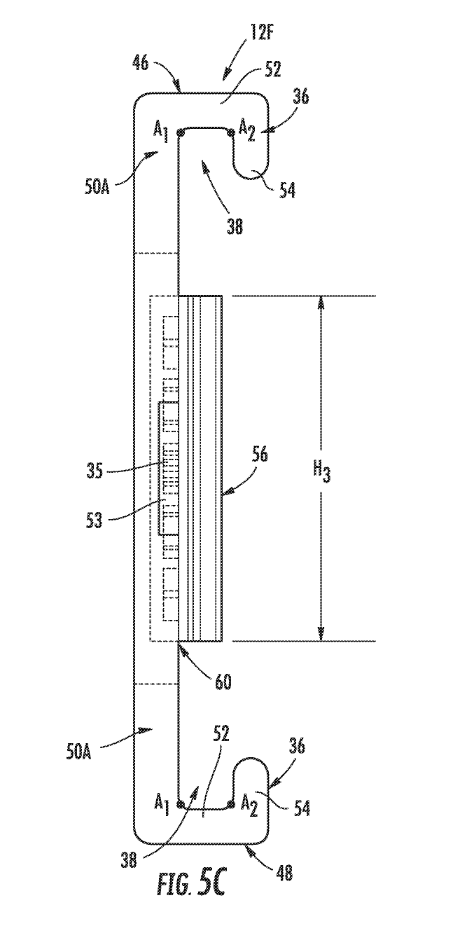

As illustrated in FIG. 4 and described in more detail in this disclosure with regard to FIGS. 5A-10, the front and rear mounting clips 12F, 12R each have lip portions 36A, 36B. The lip portions 36A, 36B form guides or rail guides 38A, 38B that are configured to receive the elongated sections 32A, 32B of the mounting brackets 24A, 24B as the fiber optic apparatus 10 is installed in the equipment rack 14. In this manner, the elongated sections 32A, 32B of the mounting brackets 24A, 24B form rails that can be received and traverse about the rail guides 38A, 38B formed in the front and rear mounting clips 12F, 12R when the fiber optic apparatus 10 is installed in the mounting brackets 24A, 24B. The rail guides 38A, 38B in the front and rear mounting clips 12F, 12R provide for alignment of the mounting brackets 24A, 24B with the fiber optic apparatus 10 during installation and prevent the fiber optic apparatus 10 from moving relative to the mounting brackets 24A, 24B in the vertical direction (as indicated by direction V₁ in FIG. 4). Also note that in this embodiment, two sets of lip portions 36A, 36B are provided in both the front and rear mounting clips 12F, 12R. This is because the front and rear mounting clips 12F, 12R are symmetrical and can be flipped to be installed on either the right or left side 34A, 34B of the housing 16, as will be described in more detail below. Alternatively, only one lip portion 36A, 36B could be included in either one or both the front and rear mounting clips 12F, 12R.

The fiber optic apparatus 10 can be installed in the mounting brackets 24A, 24B such that either the front mounting clip 12F or the rear mounting clip 12R first receives the elongated sections 32A, 32B of the mounting brackets 24A, 24B. As discussed above, if the rear mounting clips 12R first receive the elongated sections 32A, 32B, as illustrated in FIG. 3, this means a rear end 40 of the housing 16 of the fiber optic apparatus 10 was first aligned with the mounting brackets 24A, 24B when installing the fiber optic apparatus 10 in the mounting brackets 24A, 24B. The fiber optic apparatus 10 is then pushed back in the depth direction D₃, as illustrated in FIG. 3, so that the front mounting clips 12F also receive the elongated sections 32A, 32B of the mounting brackets 24A, 24B, as illustrated in FIG. 4. Alternatively, if the front mounting clips 12F first receive the elongated sections 32A, 32B (not illustrated), this means a front end 42 (shown in FIG. 3), as opposed to the rear end 40, of the housing 16 of the fiber optic apparatus 10 was first aligned with the mounting brackets 24A, 24B when installing the fiber optic apparatus 10 in the mounting brackets 24A, 24B. In this scenario, the fiber optic apparatus 10 would be pushed forward in the depth direction D₄, as illustrated in FIG. 3, for the front mounting clips 12F and then the rear mounting clips 12R to be received by the elongated sections 32A, 32B of the mounting brackets 24A, 24B, as illustrated in FIG. 4.

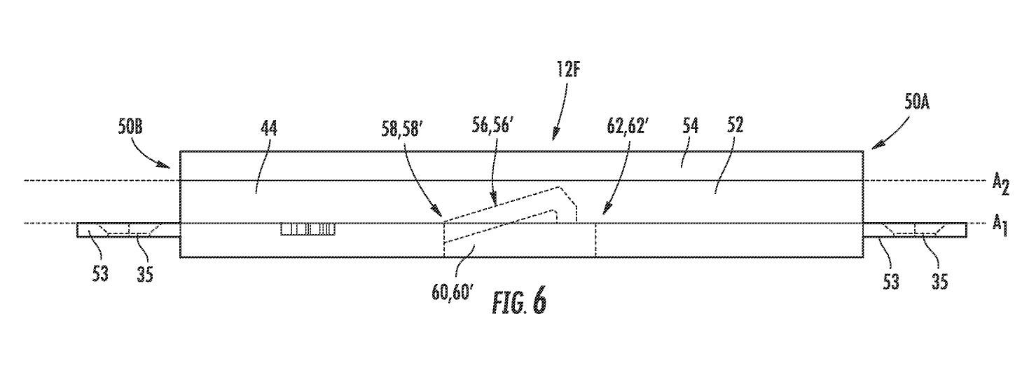

FIGS. 5A-10 illustrate more detail regarding the front and rear mounting clips 12F, 12R and how the front and rear mounting clips 12F, 12R received the mounting brackets 24A, 24B to secure the fiber optic apparatus 10 to the mounting brackets 24A, 24B, and thus to the equipment rack 14 in FIG. 1. FIGS. 5A and 5B illustrate perspective views of the front and back sides of the front mounting clip 12F, respectively. FIG. 5C illustrates a front view of the front mounting clip 12F in FIGS. 5A and 5B. FIG. 6 illustrates a top view of the front mounting clip 12F in FIGS. 5A and 5B. The front mounting clip 12F illustrated in FIGS. 5A-5C is constructed as a single piece. The front mounting clip 12F may be made from any material desired, such as a polymer, including but not limited to mineral-filled noryl, Lexan®, and ultem, as examples.

As illustrated in FIGS. 5A-5C, the front mounting clip 12F is comprised of a generally planar, elongated portion 44 having a top side 46, a bottom side 48, and front and rear ends 50A, 50B. The top side 46 and bottom side 48 of the front mounting clip 12F are comprised of the lip portions 36 that form the rail guides 38 configured to receive the elongated sections 32A, 32B of the mounting brackets 24A, 24B, as previously discussed and illustrated in FIG. 4. The lip portions 36 in this embodiment are comprised of a first portion 52 orthogonal to the elongated portion 44, and a second portion 54 orthogonal to the first portion 52 and generally parallel to the elongated portion 44. The lip portions 36 may be formed by the top side 46 and bottom side 48 being bent along two axes A₁, A₂, as shown in FIGS. 5A-5C. The elongated portion 44 in this embodiment also include mounting platforms 53 defining the apertures 37 therethrough which are disposed on both the front and rear ends 50A, 50B to facilitate attachment of the front mounting clip 12F to the housing 16. Fasteners 35 (FIG. 3) can be disposed in the apertures 37 to attach the front mounting clip 12F to the housing 16, as illustrated in FIG. 3.

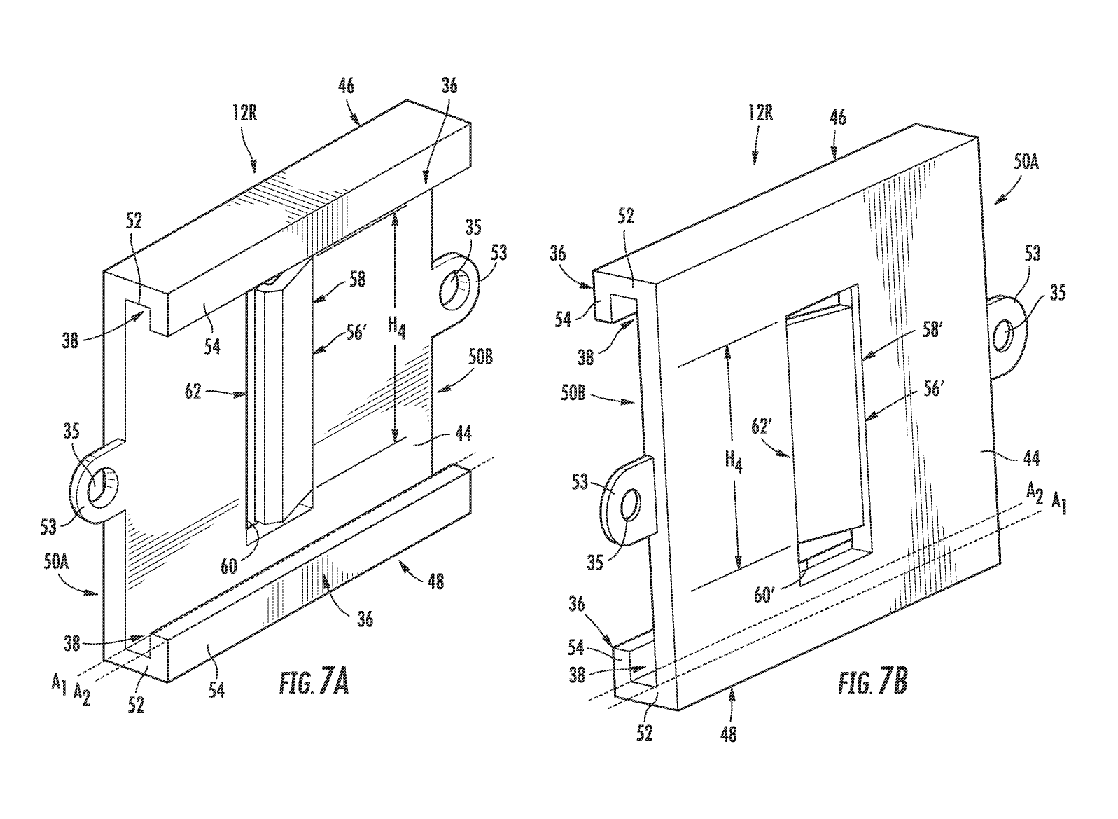

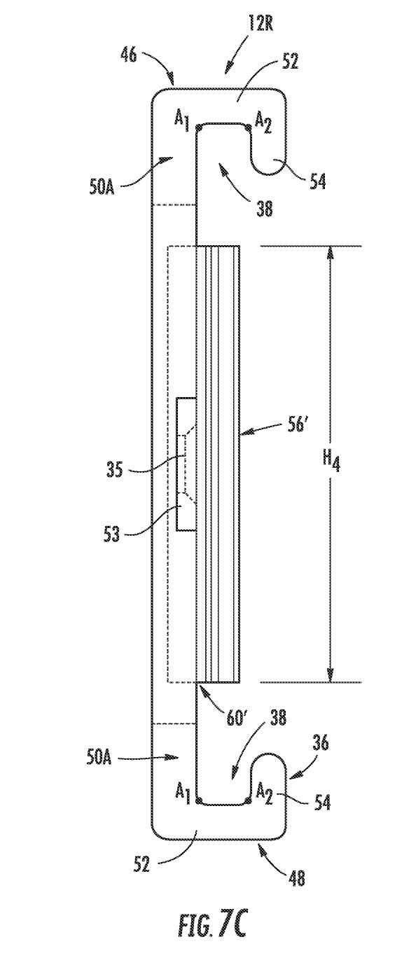

The rear mounting clip 12R contains many of the same features as the front mounting clip 12F, as will be described next with regard to FIGS. 7A-7C. FIGS. 7A and 7B illustrate perspective views of the front and back sides of the rear mounting clip 12R, respectively. FIG. 7C illustrates a front view of the rear mounting clip 12R in FIGS. 7A and 7B. FIG. 6 also illustrates a top view of the rear mounting clip 12R in FIGS. 7A and 7B, because the front and rear mounting clips 12F, 12R appear the same from a top view. Like the front mounting clip 12F in FIGS. 5A-5C, the rear mounting clip 12R illustrated in FIGS. 7A-7C is also constructed as a single piece in this embodiment. The rear mounting clip 12R may be made from any material desired, such as a polymer, including but not limited to mineral-filled noryl, Lexan®, and ultem, as examples. The same features present between the front mounting clip 12F of FIGS. 5A-5C and the rear mounting clip 12R in FIGS. 7A-7C are noted by the same element numbers in FIGS. 5A-5C and FIGS. 7A-7C. The previous discussion of these features with regard to FIGS. 5A-5C is equally applicable to FIGS. 7A-7C and thus will not be repeated.

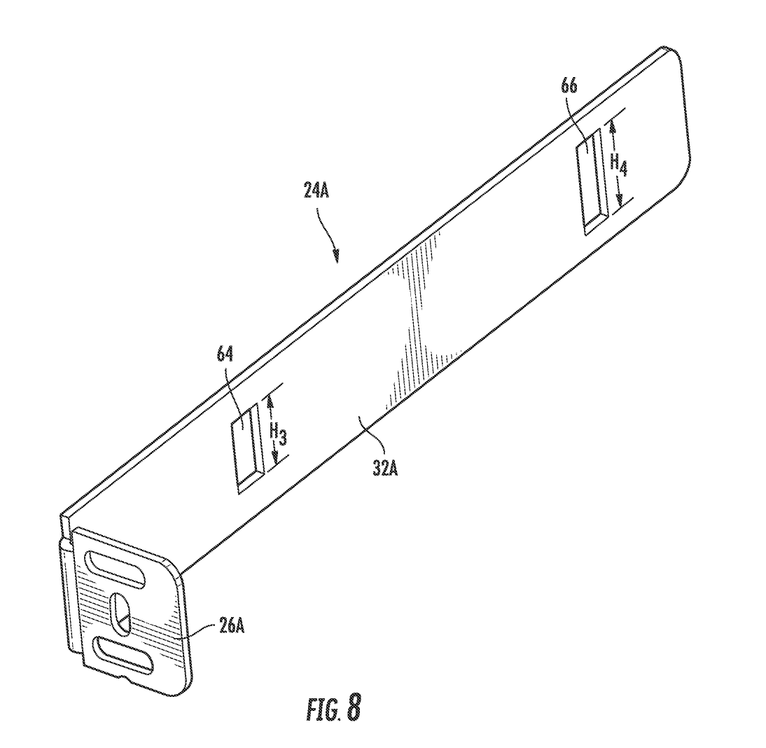

As illustrated in FIGS. 5A-5C and FIGS. 7A-7C, respectively, the front and rear mounting clips 12F, 12R in this embodiment include a front latch 56 and a rear latch 56′, respectively (also referred to herein as “latch 56” and “latch 56′, respectively”). Both latches 56, 56′ in this embodiment are biased outward from the elongated portions 44 of the front and rear mounting clips 12F, 12R. The latches 56, 56′ are each configured to engage with a front and rear opening 64, 66, respectively, in the right-side mounting bracket 24A, as illustrated in FIG. 8, to lock the mounting bracket 24 to the front and rear mounting clips 12F, 12R. In this embodiment, as illustrated in FIGS. 5A-5C and FIGS. 7A-7C, the latches 56, 56′ are cantilevers that are each securely attached to one side 58, 58′ of the elongated portion 44 of the front and rear mounting clips 12F, 12R, respectively. The latches 56, 56′ are disposed through openings 60, 60′ disposed in the elongated portions 44 of the front and rear mounting clips 12F, 12R, respectively. The latches 56, 56′ are free to move on another side 62, 62′ of the elongated portions 44 of the front and rear mounting clips 12F, 12R, respectively.

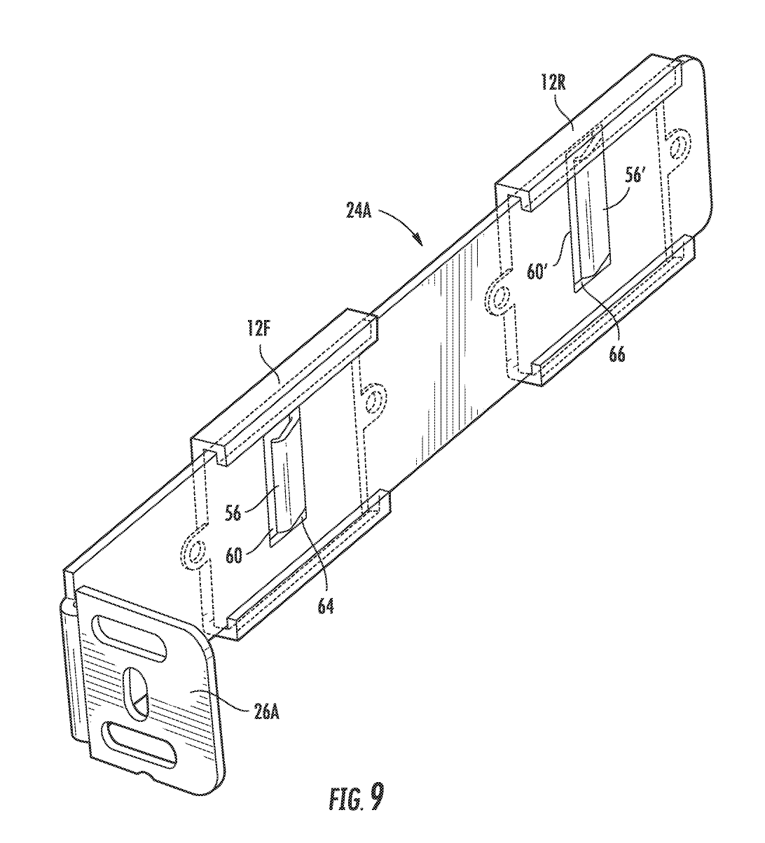

In this embodiment, the latches 56, 56′ are biased outward and configured to move inward and outward on the sides 62, 62′ and through the openings 60, 60′ on the elongated portions 44 of the front and rear mounting clips 12F, 12R, respectively. The latches 56, 56′ bend inward as the front and rear mounting clips 12F, 12R are moved about the elongated section 32A of the mounting bracket 24A due to the interference between the latches 56, 56′ and the elongated section 32A, as illustrated in FIG. 4. As the latches 56, 56′ move across the front and rear openings 64, 66, respectively, and the housing 16 is moved about the mounting bracket 24A, there will no longer be interference between the elongated section 32A and the latches 56, 56′. In this regard, the latches 56, 56′, by being biased outward, will move outward from the elongated portion 44 of the front and rear mounting clips 12F, 12R, respectively, into the front and rear openings 64, 66 of the mounting bracket 24A, respectively, as illustrated in FIG. 9. In this manner, the front and rear mounting clips 12F, 12R, and thus the housing 16 of the fiber optic apparatus 10, are locked into place with regard to the mounting bracket 24A.

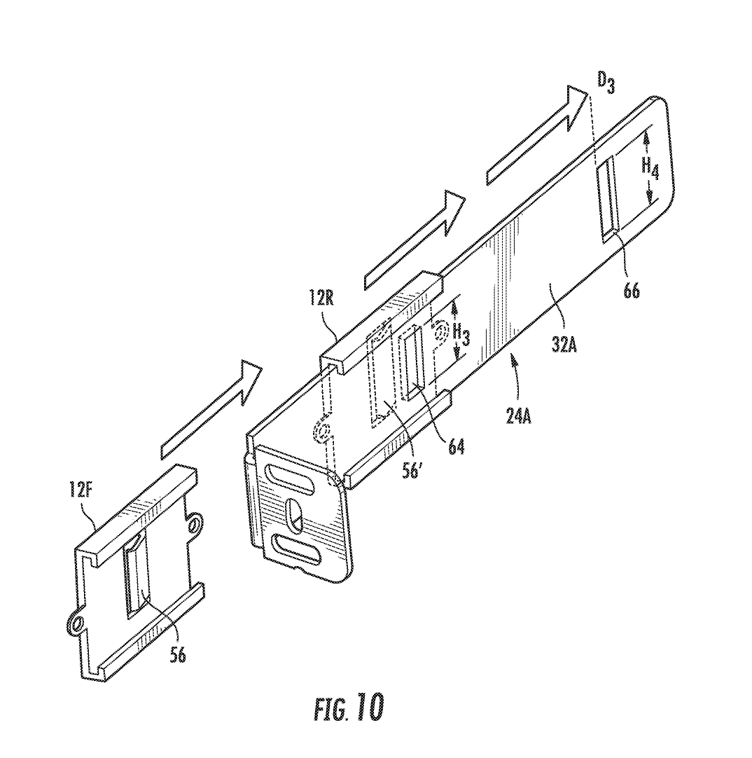

As illustrated in the front and rear mounting clips 12F, 12R in FIGS. 5A-5C and FIGS. 7A-7C, respectively, the height H₃ of the latch 56 disposed in the front mounting clip 12F is shorter than the height H₄ of the latch 56′ disposed in the rear mounting clip 12R in this embodiment. In this regard, the front opening 64 of the mounting bracket 24A is of height H₃ and the rear opening 66 of the mounting bracket 24A is of height H₄, as illustrated in FIG. 8. This configuration is provided in this embodiment so that the latch 56′ disposed in the rear mounting clip 12R does not engage with the front opening 64 of the mounting bracket 24A after the rear mounting clip 12R receives the elongated section 32A of the mounting bracket 24A and the housing 16 (FIG. 3) is moved in direction D₃, as illustrated in FIG. 10. The latch 56′, by being of height H₃ taller than the height H₄ of the front opening 64, will continue to interfere with the section 32A of the mounting bracket 24A continuing to push the latch 56′ inward as the latch 56′ passes over the front opening 64 of the mounting bracket 24A when moving in direction D₃, as illustrated in FIG. 10. The rear mounting clip 12R continues to move about the elongated portion 44 of the mounting bracket 24A until the latch 56′ of the rear mounting clip 12R is engaged with the rear opening 66 and the latch 56 of the front mounting clip 12F is engaged with the front opening 64, as illustrated in FIG. 9. If the height of the latch 56′ of the rear mounting clip 12R was designed to allow engagement with the front opening 64, the latch 56′ would engage with and lock into the front opening 64 preventing the housing 16 from further moving in direction D₃. In this regard, the front mounting clip 12F would be prevented from receiving the elongated portion 44 of the mounting bracket 24A.

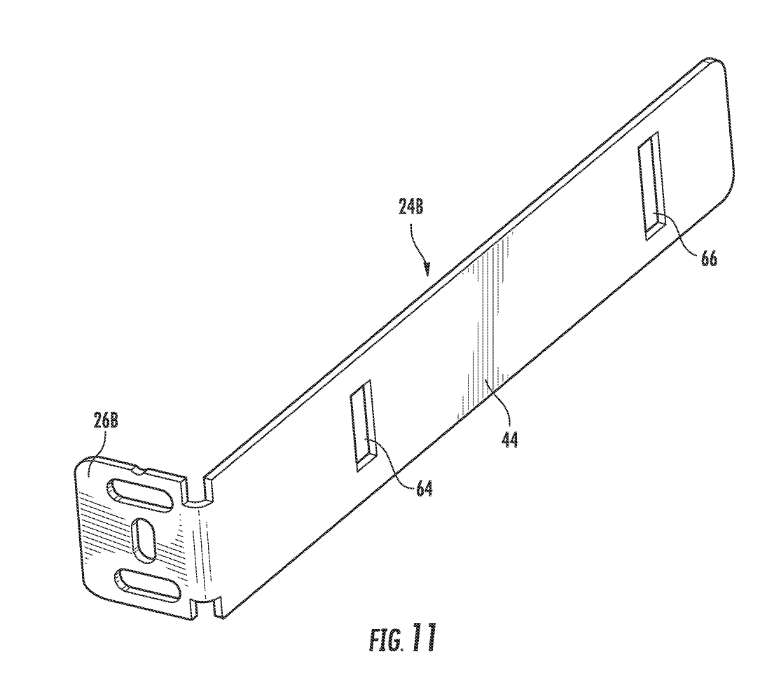

Note that while FIGS. 5A-10 illustrate examples of the front and rear mounting clips 12F, 12R receiving the elongated portion 44 of the right-side mounting bracket 24A, the front and rear mounting clips 12F, 12R can also receive the elongated portion 44 of the left-side mounting bracket 24B, which is illustrated in FIG. 11. The front and rear mounting clips 12F, 12R in FIGS. 5A-10 are symmetrical and can be rotated or flipped to be attached on either the right side 34A or left side 34B of the housing 16 of the fiber optic apparatus 10, as illustrated in FIG. 2. Thus, the discussion above with regard to the front and rear mounting clips 12F, 12R and the right-side mounting bracket 24A is equally applicable for the operation and function if the front and rear mounting clips 12F, 12R were attached to the left side 34B of the housing 16 and receiving the left-side mounting bracket 24B.

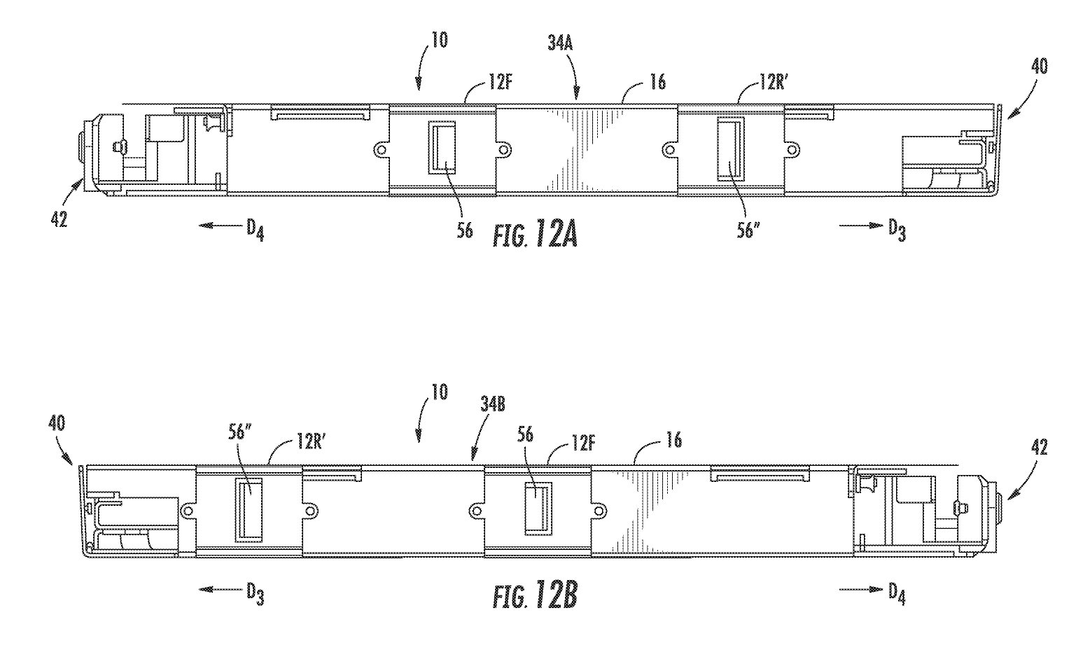

FIGS. 12A and 12B illustrate the fiber optic apparatus 10 of FIG. 1, but with alternate rear mounting clips 12R′ installed on the housing 16. FIG. 12A illustrates the right side 34A of the housing 16, and FIG. 12B illustrates the left side 34B of the housing 16. The rear mounting clip 12R′ contains the same features as the rear mounting clip 12R illustrated in FIGS. 7A-7C, except that as illustrated in FIGS. 12A and 12B, latches 56″ disposed in the rear mounting clips 12R′ are biased outward in an opposing direction to the biasing of the latches 56 disposed in the front mounting clips 12F. The latches 56, once engaged with the front openings 64 in the mounting brackets 24A, 24B (FIGS. 8 and 11), prevent the housing 16 from moving forward in direction D₄. However, by the latches 56″ being biased outward in an opposite direction from the latches 56, when the latches 56″ are engaged with the front openings 64 in the mounting brackets 24A, 24B (FIGS. 8 and 11), the housing 16 is also prevented from moving back in direction D₃. The rear mounting clips 12R′ may be deployed in the embodiments of FIGS. 5A-10 described above, if desired.

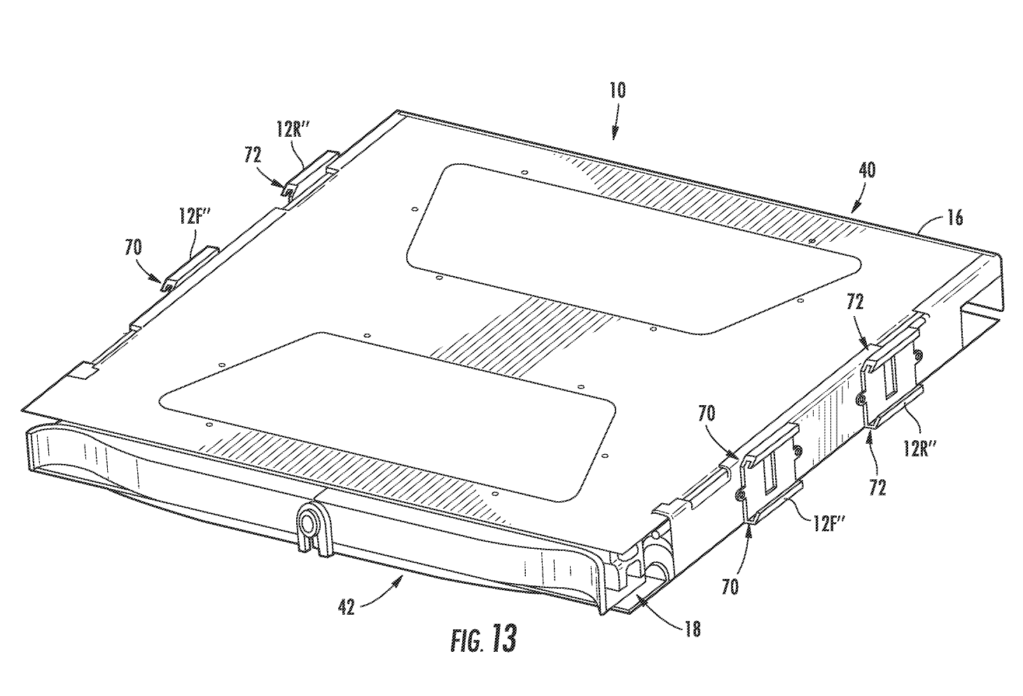

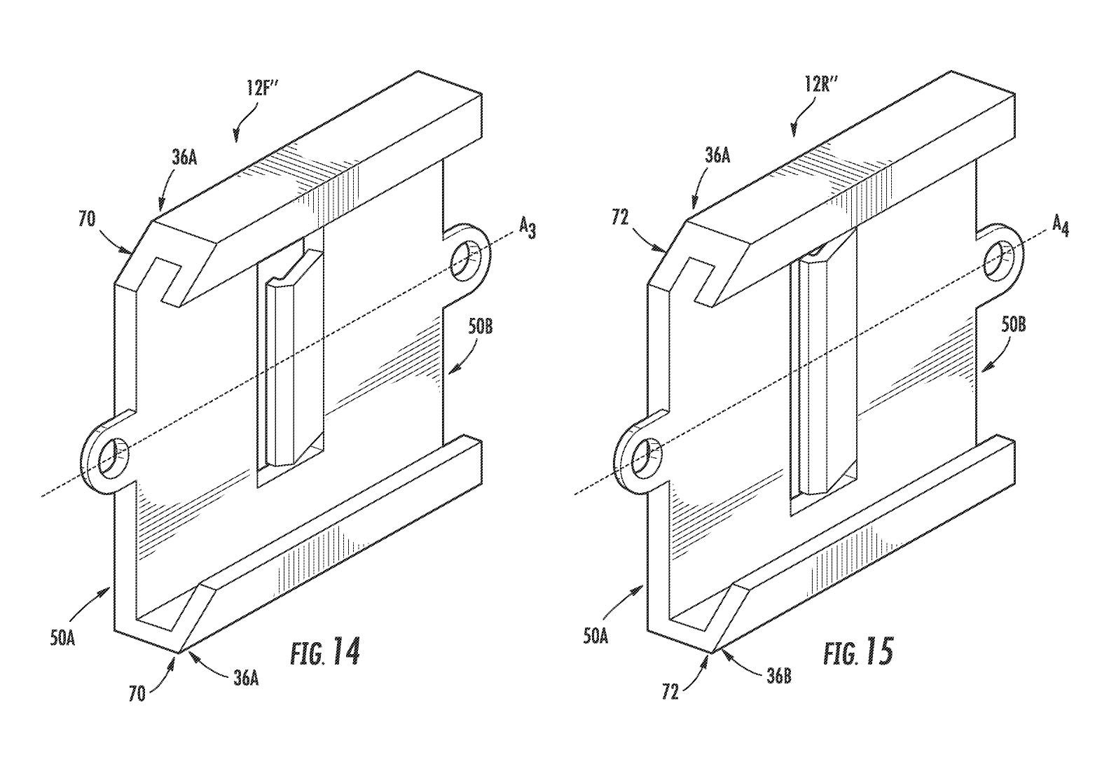

FIGS. 13-15 illustrate additional alternative embodiments of the front and rear mounting clips 12F″, 12R″ that may be employed attached to the housing 16 in FIGS. 1-4. As illustrated in FIG. 13, the front and rear mounting clips 12F″, 12R″ are mounted to the housing 16 like the front and rear mounting clips 12F, 12R are mounted to the housing 16 in FIGS. 1-4. However, in this embodiment, the front and rear mounting clips 12F″, 12R″ include angled portions 70, 72, respectively. The angled portions 70, 72 may assist in the front and rear mounting clips 12F″, 12R″ receiving the elongated portions 44 of the mounting brackets 24A, 24B. FIGS. 14 and 15 illustrate perspective views of the front and rear mounting clips 12F″, 12R″, respectively, to further illustrate the angled portions 70, 72. As illustrated, the front and rear mounting clips 12F″, 12R″ are the same and contain the same features as the front and rear mounting clips 12F, 12R in FIGS. 5A and 7A, respectively, except that angled portions 70, 72 are disposed on the front end 50A of the lip portions 36A, 36B. In this embodiment, the angled portions 70, 72 are formed from cuts at approximately forty-five (45) degree angles with respect to longitudinal axes A₃, A₄ of the front and rear mounting clips 12F″, 12R″, respectively. However, the angled portions 70, 72 could be disposed at any angle desired.

Many modifications and other embodiments of the invention set forth herein will come to mind to one skilled in the art to which the invention pertains having the benefit of the teachings presented in the foregoing descriptions and the associated drawings. These modifications include, but are not limited to, the type of fiber optic equipment or apparatus, the type fiber optic equipment rack or cabinet, the type, shape and/or size of a mounting bracket(s), the shape, size, including but not limited to the length, of the mounting clip(s), the manner in which the mounting clip(s) is attached to the fiber optic apparatus, the material type of the mounting clip(s), the number of mounting clips employed to support a fiber optic apparatus in a fiber optic equipment rack or cabinet, whether a latch is employed in the mounting clip and the type of latch, whether an opening disposed in a mounting clip and its size, etc. For example, a single mounting clip may be attached on a side of a fiber optic apparatus that spans the same length as the length between the front and rear mounting disclosed in one of the embodiments described herein.

Further, as used herein, it is intended that the terms “fiber optic cables” and/or “optical fibers” include all types of single mode and multi-mode light waveguides, including one or more optical fibers that may be upcoated, colored, buffered, ribbonized and/or have other organizing or protective structure in a cable such as one or more tubes, strength members, jackets or the like. Likewise, other types of suitable optical fibers include bend-insensitive optical fibers, or any other expedient of a medium for transmitting light signals. An example of a bend-insensitive optical fiber is ClearCurve® Multimode fiber commercially available from Corning Incorporated.

It is to be understood that the invention is not to be limited to the specific embodiments disclosed and that modifications and other embodiments are intended to be included within the scope of the appended claims. It is intended that the present invention cover the modifications and variations of this invention provided they come within the scope of the appended claims and their equivalents. Although specific terms are employed herein, they are used in a generic and descriptive sense only and not for purposes of limitation.

What is claimed is:

1. A fiber optic apparatus, comprising:
a housing;
at least one optical component supported in the housing; and
at least one mounting clip attached to at least one side of the housing configured to receive at least one mounting bracket configured to be installed on a fiber optic equipment rack to install the housing in the fiber optic equipment rack.

2. The fiber optic apparatus of claim 1, wherein the at least one mounting clip defines at least one rail guide configured to receive a rail of the at least one mounting bracket.

3. The fiber optic apparatus of claim 2, wherein the at least one rail guide is formed from at least one lip portion disposed in the at least one mounting clip.

4. The fiber optic apparatus of claim 1, further comprising at least one latch disposed in the at least one mounting clip.

5. The fiber optic apparatus of claim 4, wherein the at least one latch is comprised of at least one cantilever.

6. The fiber optic apparatus of claim 4, further comprising at least one angle disposed in the at least one latch.

7. The fiber optic apparatus of claim 4, wherein the at least one latch is configured to be received through an opening disposed in the at least one mounting bracket to secure the at least one mounting clip to the at least one mounting bracket.

8. The fiber optic apparatus of claim 4, wherein the at least one latch is biased towards a front end of the housing.

9. The fiber optic apparatus of claim 4, wherein the at least one latch is biased towards a rear end of the housing.

10. The fiber optic apparatus of claim 4, wherein the at least one mounting clip is comprised of a front mounting clip and a rear mounting clip.

11. The fiber optic apparatus of claim 10, further comprising a front latch disposed in the front mounting clip and a rear latch disposed in the rear mounting clip.

12. The fiber optic apparatus of claim 11, wherein the front latch and the rear latch are biased in the same direction along the at least one side of the housing.

13. The fiber optic apparatus of claim 11, wherein the front latch and the rear latch are biased in opposite directions along the at least one side of the housing.

14. The fiber optic apparatus of claim 11, further comprising a front opening disposed in the front latch of a first height, and a second opening disposed in the rear latch of a second height taller than the first height.

15. The fiber optic apparatus of claim 11, wherein the front latch is configured to be received through a front opening disposed in the at least one mounting bracket, and wherein the rear latch is configured to be received through a rear opening disposed in the at least one mounting bracket.

16. The fiber optic apparatus of claim 1, wherein the at least one mounting clip is comprised of at least one left-side mounting clip attached to a left side of the housing and at least one right-side mounting clip attached to a right side of the housing.

17. The fiber optic apparatus of claim 1, further comprising at least one mounting orifice disposed in the at least one mounting clip configured to receive at least one fastener to attach the at least one mounting clip to the at least one side of the housing.

18. The fiber optic apparatus of claim 1, further comprising at least one angled surface disposed in at least one side of the at least one mounting clip.

19. A method of installing a fiber optic apparatus in a fiber optic equipment rack, comprising:
attaching at least one mounting bracket to the fiber optic equipment rack;
aligning at least one mounting clip attached to at least one side of a housing supporting at least one optical component with the at least one mounting bracket;
receiving the at least one mounting bracket in the at least one mounting clip; and
translating the at least one mounting clip along the at least one mounting bracket.

20. The method of claim 19, wherein receiving the at least one mounting bracket in the at least one mounting clip comprises receiving at least one rail disposed in the at least one mounting bracket in at least one rail guide disposed in the at least one mounting clip.

21. The method of claim 19, wherein receiving the at least one mounting bracket in the at least one mounting clip comprises receiving the at least one mounting bracket in a front mounting clip and a rear mounting clip attached to the at least one side of the housing.

22. The method of claim 19, further comprising disposing at least one latch disposed in the at least one mounting clip through at least one opening disposed in the at least one mounting bracket.

23. The method of claim 22, wherein disposing the at least one latch is comprised of disposing a front latch through a front opening disposed in the at least one mounting bracket and a rear latch through a rear opening in the at least one mounting bracket.

24. The method of claim 23, wherein the front latch and the rear latch are biased in opposite directions along the at least one side of the housing.

25. A fiber optic apparatus, comprising:
a housing;
at least one optical component supported in the housing;
a first front mounting clip and a first rear mounting clip attached to a left side of the housing and each configured to receive a left-side mounting bracket configured to be installed on a fiber optic equipment rack;
a second front mounting clip and a second rear mounting clip attached to a right side of the housing and each configured to receive a right mounting bracket configured to be installed on a fiber optic equipment rack;
a first front latch disposed in the first front mounting clip and a first rear latch disposed in a first rear mounting clip each configured to be received in a front opening and a rear opening, respectively, disposed in the left-side mounting bracket; and
a second front latch disposed in the second front mounting clip and a second rear latch disposed in a second rear mounting clip each configured to be received in a front opening and a rear opening, respectively, disposed in the right mounting bracket.

26. The fiber optic apparatus of claim 25, wherein the first front latch and the first rear latch are biased in opposite directions from each other along the left side of the housing; and
wherein the second front latch and the second rear latch are biased in opposite directions from each other along the right side of the housing.
